(19) United States
(12) Patent Application Publication
(10) Pub. No.: US 2020/0042238 A1
(43) Pub. Date: Feb. 6, 2020

(54) DATA STORAGE DEVICE, METHOD OF OPERATING THE SAME, AND STORAGE SYSTEM HAVING THE SAME

(71) Applicant: SK hynix Inc., Gyeonggi-do (KR)

(72) Inventors: Hoe Seung JUNG, Seoul (KR); Jae Hyeong JEONG, Gyeonggi-do (KR)

(21) Appl. No.: 16/212,221

(22) Filed: Dec. 6, 2018

(30) Foreign Application Priority Data
Aug. 3, 2018 (KR) 10-2018-0090670

(51) Int. Cl. G06F 3/06

(52) U.S. Cl. CPC G06F 3/0659; G06F 3/0625; G06F 3/0673; G06F 3/0604

(57) ABSTRACT

A data storage device may include a storage configured to temporarily suspend an operation thereof at a specified time; and a controller configured to schedule an operation resume time as the storage temporarily suspends the operation, and transmit an operation resume signal to the storage according to a result of the scheduling.

### CROSS-REFERENCE TO RELATED APPLICATION

The present application claims priority under 35 U.S.C. § 119(a) to Korean application number 10-2018-0090670, filed on Aug. 3, 2018, in the Korean Intellectual Property Office, which is incorporated herein by reference in its entirety.

### BACKGROUND

### 1. Technical Field

Various embodiments generally relate to a semiconductor integrated device, and, more particularly, to a data storage device, a method of operating the data storage device, and a storage system having the data storage device.

### 2. Related Art

A storage device is coupled with a host device and configured to perform a data input/output operation in response to a request of the host. The storage device may use various storage mediums to store data.

In storage devices, which have been recently developed and produced, a plurality of storage mediums are coupled to a controller in a multi-channel or multi-way structure, whereby parallelism in data access may be enhanced to promote improvement in system performance.

As the number of high-capacity storage mediums which are simultaneously operated is increased, it becomes more likely that the time at which peak current occurs in one of the storage mediums overlaps the peak occurrence time in one or more other storage mediums. Due to excessive peak current, a drop of supply voltage, a signal noise, power interruption, and the like may be caused.

### SUMMARY

In an embodiment, a data storage device may include: a storage configured to temporarily suspend an operation thereof at a specified time; and a controller configured to schedule an operation resume time as the storage temporarily suspends the operation, and transmit an operation resume signal to the storage according to a result of the scheduling.

In an embodiment, a method of operating a data storage device comprising a storage and a controller configured to control data exchange with the storage may include: setting the storage to temporarily suspend an operation thereof at or before a peak current occurrence time; temporarily suspending, by the storage, the operation as the during the operation of the storage; scheduling, by the controller, an operation resume time; and transmitting, by the controller, an operation resume signal to the storage according to a result of the scheduling.

In an embodiment, a storage system may include: a host device; and a data storage device comprising a storage configured to temporarily suspend an operation thereof at a specified time, and a controller configured to control the storage, wherein the controller is configured to schedule an operation resume time as the storage temporarily suspends the operation, and transmit an operation resume signal to the storage according to a result of the scheduling.

In an embodiment, a data storage device may include: one or more data storage elements each configured to suspend before a specified period an operation determined to consume a set amount of power during the specified period; and a controller configured to control each of the data storage elements to resume the corresponding suspended operation so as to maintain power consumption of the data storage elements within a power consumption budget, wherein each of the data storage elements notifies the controller of the corresponding suspended operation.

### BRIEF DESCRIPTION OF THE DRAWINGS

FIG. 1 is a diagram illustrating a configuration of a data storage device in accordance with an embodiment.

FIGS. 2 and 3 are diagrams for describing a power management according to an internal operation of a storage.

FIG. 4 is a diagram illustrating a configuration of a controller in accordance with an embodiment.

FIG. 5 is a diagram illustrating a configuration of a power manager in accordance with an embodiment.

FIGS. 6A to 6C are diagrams for describing an example of scheduling according to peak current occurrence periods.

FIG. 7 is a flowchart for describing a method of operating the data storage device in accordance with an embodiment.

FIG. 8 is a diagram illustrating a data storage system in accordance with an embodiment.

FIG. 9 and FIG. 10 are diagrams illustrating a data processing system in accordance with an embodiment.

FIG. 11 is a diagram illustrating a network system including a data storage device in accordance with an embodiment.

FIG. 12 is a block diagram illustrating a nonvolatile memory device included in a data storage device in accordance with an embodiment.

### DETAILED DESCRIPTION

A data storage device and a method of the data storage device will be described below with reference to the accompanying drawings through various embodiments. Throughout the specification, reference to “an embodiment” or the like is not necessarily to only one embodiment, and different references to any such phrase are not necessarily to the same embodiment(s).

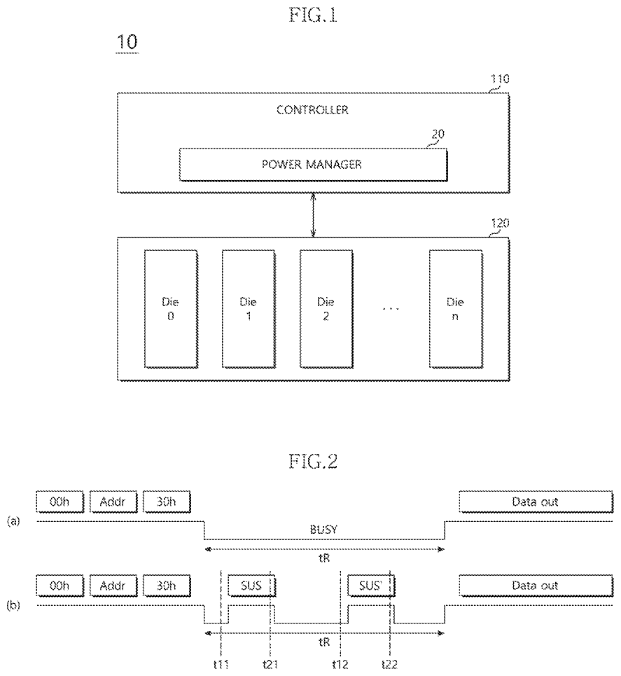

FIG. 1 is a diagram illustrating a configuration of a data storage device 10 in accordance with an embodiment.

Referring to FIG. 1, the data storage device 10 in accordance with an embodiment may include a controller 110 and a storage 120.

The controller 110 may control the storage 120 in response to a request of a host device. For example, the controller 110 may enable data to be programmed to the storage 120 in response to a program (write) request of the host device. Furthermore, the controller 110 may provide data stored in the storage 120 to the host device in response to a read request of the host device.

The storage 120 may store data or output stored data under control of the controller 110. The storage 120 may be formed of a volatile or nonvolatile memory device. In an embodiment, the storage 120 may be embodied using a memory element selected from among various nonvolatile memory elements such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM). The storage 120 may include a plurality of dies Die 0 to Die n, a plurality of chips, or a plurality of packages. In addition, the storage 120 may be formed of single-level cells each capable of storing one bit of data, or multi-level cells each capable of storing a plurality of bits of data.

During a parallel processing or interleaving operation for the plurality of dies Die 0 to Die n constituting the storage 120, there is a need to manage power consumption of each or entirety of the plurality of dies Die 0 to Die n.

The reason for this is because, when simultaneously accessing the dies Die 0 to Die n in the storage 120 for enhancing performance of the system, the sum of instantaneous current consumption at a particular time may exceed an allowable limit of the system.

The power manager 20 may be configured to schedule operation times and/or an operation sequence of the plurality of dies Die 0 to Die n constituting the storage 120 based on an operation state of the storage 120.

Operations which are operated in the storage 120 may be chiefly divided into a write operation and a read operation. Each of the write operation and the read operation may include detailed operations such as a process of applying an operating voltage, and a process of transmitting data to be written or read to an internal or external device of the storage 120.

Of course, current consumption of each operating process of the storage 120 may be changed depending on a data storage method (SLC, MLC) of memory cells constituting the storage 120, a writing/reading scheme, etc.

The power manager 20 may specify a peak current occurrence period including at least one peak current occurrence time depending on characteristics of the storage 120. The storage 120 may be configured or preset such that, before entering a specified peak current occurrence period, the operation of each of the dies Die 0 to Die n of the storage 120 is temporarily suspended. In an embodiment, the characteristics of the storage 120 may include a data storage method, a writing scheme, a reading scheme, etc. of the memory cells, but it is not limited thereto.

In other words, when a point in time (a peak current occurrence time) to perform a specific operation approaches, the storage 120 may temporarily suspend the specific operation and notify the power manager 20 that the operation has been temporarily suspended.

If the power manager 20 is notified of the temporary suspension of the specific operation by at least one of the dies Die 0 to Die n, the power manager 20 may schedule an operation resume time and/or an operation resume sequence. For this later operation, the attributes of the temporarily suspended operation may be taken into account. Furthermore, according to a result of scheduling, temporarily suspended operations may be sequentially resumed. The resume and/or sequence of the operations may be scheduled by dies, or may be scheduled by attributes of the temporarily suspended operations.

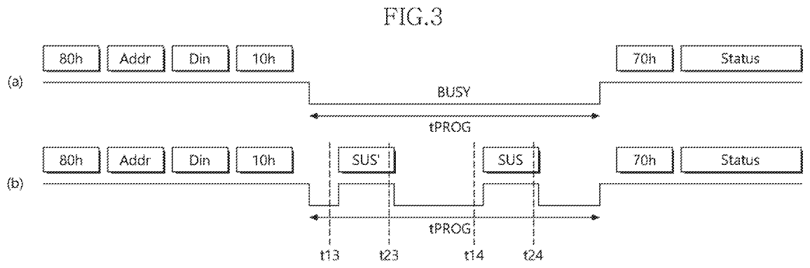

FIGS. 2 and 3 are diagrams for describing power management according to an internal operation of the storage 120.

FIG. 2 is a diagram for describing a power management concept during a read operation.

As shown in (a) of FIG. 2, during a general read operation, a first read command 00h, an address Addr and a second read command 30h are input, and then a read operation is performed during a busy period tR. During the busy period tR, data may be fetched from memory cells and transferred to page buffers. After the busy period tR, the data may be outputted from the storage (as shown by “Data out”).

At least one peak current occurrence period may be included in the busy period tR.

In the embodiment, as shown in (b) of FIG. 2, at each of time points t11 and t12, before entering a peak current occurrence period, the storage 120 may temporarily suspend specific operations (as shown by “SUS”) and notify the power manager 20 that the operations have been temporarily suspended. In addition, the power manager 20 may schedule an operation resume sequence based on attributes of temporarily suspended operations. The power manager 20 may transmit resume commands at each of time points t21 and t22, at which the temporarily suspended operations are to be resumed, according to a result of the scheduling, and thus sequentially resume the temporarily suspended operations.

FIG. 3 is a diagram for describing a power management concept during a program operation.

As shown in (a) of FIG. 3, during a general program operation, a first program command 80h, an address Addr and data Din are sequentially inputted, a second program command 10h is inputted, and then a program operation is performed during a busy period tPROG. During the busy period tPROG, data latched in the page buffer may be written to memory cells. After the busy period tPROG, i.e., after the program operation is completed, the controller 110 may transmit a status read command 70h. In response to this, the storage 120 may transmit status information Status and check whether the program operation has been normally performed.

At least one peak current occurrence period may be included in the busy period tPROG.

In the embodiment, as shown in (b) of FIG. 3, at each of time points t13 and t14, before entering a peak current occurrence period, the storage 120 may temporarily suspend specific operations (as shown by “SUS”) and notify the power manager 20 that the operations have been temporarily suspended. In addition, the power manager 20 may schedule an operation resume sequence based on attributes of temporarily suspended operations. The power manager 20 may transmit resume commands at each of time points t23 and t24, at which the temporarily suspended operations are to be resumed, according to a result of the scheduling, and thus sequentially resume the temporarily suspended operations.

In an embodiment, through a test process, a result of measuring the amount of current which is consumed during an operation of each of the plurality of dies Die 0 to Die n constituting the storage 120 is profiled, and a peak current occurrence period including at least one peak current occurrence time may be specified. The storage 120 may be controlled such that the storage 120 temporarily suspends the specific operation by itself before entering the at least one specified peak current occurrence period.

For example, the peak current occurrence time may be one or more of the following points in time.

1. a point in time at which higher current is instantaneously used compared to that of a preceding point in time.

2. a point in time at which the amount of current begins to gently or consistently increase compared to that of a preceding point in time.

3. a point in time at which the amount of current exceeds a threshold peak current value, which may be preset.

In determining whether to resume the temporarily suspended operations, one or more of the following items may be taken into account.

1. priority or priorities of operations and commands set in the controller 110.

2. attributes (user data, map data, metadata, etc.) of data to be processed.

3. an allowed power budget and peak power of each die at a peak current occurrence time.

Therefore, each of the dies Die 0 to Die n in the storage 120 may temporarily suspend the operation before a specified operation is performed. When the power manager 20 of the controller 110 is notified of the temporary suspension by each of the dies Die 0 to Die n, the power manager 20 may schedule a sequence in which the temporarily suspended operations are to be resumed. The power manager 20 may transmit an operation resume signal to each of the dies Die 0 to Die n according to a result of the scheduling, and resume the operations of the dies Die 0 to Die n. Here, taking into account the allowed power budget and the peak power of each die at the peak current occurrence time, the power manager 20 may perform the scheduling operation such that at least two dies simultaneously resume operations.

Because the dies Die 0 and Die n suspend operations requiring high current consumption before such operations are performed, and thereafter sequentially resumes the operations according to priority and/or other factors, times at which the plurality of dies Die 0 to Die n consume peak current may be prevented from overlapping each other. Such action, in turn, may prevent a drastic surge of current consumption in the storage 120.

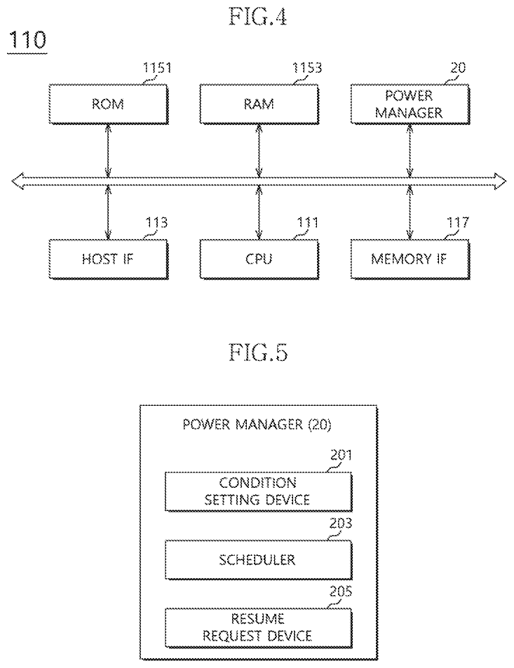

FIG. 4 is a diagram illustrating a configuration of the controller in accordance with an embodiment.

Referring to FIG. 4, the controller 110 in accordance with an embodiment may include a central processing unit (CPU) 111, a host interface 113, a ROM 1151, a RAM 1153, a memory interface 20, and a power manager 20.

The CPU 111 may be configured to transmit various control information needed for a data read or write operation to the host interface 113, the RAM 1141, and the memory interface 117. In an embodiment, the CPU 111 may be operated according to firmware provided for various operations of the data storage device 10. In an embodiment, the CPU 111 may implement the function of a flash translation layer (FTL) for performing a garbage collection operation, an address mapping operation, a wear leveling operation, etc. for managing the storage 120, a function of detecting and correcting an error in data read out from the storage 120, and so forth.

The host interface 113 may provide a communication channel configured to receive a command and a dock signal from the host device and control input or output of data under control of the CPU 111. Particularly, the host interface 113 may provide physical connection between the host device and the data storage device 10. Furthermore, the host interface 113 may provide an interface with the data storage device 10 in correspondence with a bus format of the host device. The bus format of the host device may include at least one of standard interface protocols such as secure digital, universal serial bus (USB), multi-media card (MMC), embedded MMC (eMMC), a personal computer memory card international association (PCMCIA), parallel advanced technology attachment (DATA), serial advanced technology attachment (SATA), small computer system interface (SCSI), serial attached SCSI (SAS), peripheral component interconnection (PCI), PCI express (PCI-E), and universal flash storage (UFS).

The RAM 1151 may store data need for an operation of the controller 110 or data generated by the controller 110.

The ROM 1153 may store program codes (for example, store code data storing firmware or software and to be used by program codes) needed for the operation of the controller 110.

The CPU 111 may load a boot code stored in the storage 120 or the ROM 111 to the RAM 1153 during a booting operation, thus controlling a booting operation of the data storage device 10.

The memory interface 117 may provide a communication channel for signal exchange between the controller 110 and the storage 120. The memory interface 117 may write data temporarily stored in a buffer memory to the storage 120 under control of the CPU 111. In addition, the memory interface 117 may transmit data read out from the storage 120 to the buffer memory to temporarily store the data.

The power manager 20 may configure or preset the storage 120 such that before entering a period including at least one peak current occurrence time specified according to characteristics of the storage 120, each of the dies Die 0 to Die n of the storage 120 temporarily suspend the operation. When the storage 120 temporarily suspends the specific operations before entering the period including the pre-specified peak current occurrence time and notifies the power manager 20 of such suspension, the power manager 20 may schedule an operation resume sequence and operation resume times based on attributes of the temporarily suspended operations, peak power with respect to the allowed power budget, and other related factors. Furthermore, the power manager 20 may resume the temporarily suspended operations according to a result of the scheduling.

FIG. 5 is a diagram illustrating a configuration of the power manager in accordance with an embodiment.

Referring to FIG. 5, the power manager 20 may include a condition setting device 201, a scheduler 203, and a resume request device 205.

The condition setting device 201 may specify at least one peak current occurrence time according to characteristics of the storage 120.

In an embodiment, the condition setting device 201 may profile the amount of current to be consumed for processing a command of the host with respect to each of the plurality of dies Die 0 to Die n constituting the storage 120 through a test process, and then specify at least one peak current occurrence time and a period of time including the peak current occurrence time based on a result of the profiling. The condition setting device 201 may control the storage 120 such that the storage 120 temporarily suspends the specific operation by itself before entering the at least one specified peak current occurrence period. The storage 120 may temporarily suspend the operations before entering the peak current occurrence period, and notify the controller 110 that the operations have been temporarily suspended, using operation confirm commands such as a status notification signal Status and a ready/busy signal/RB.

For example, the peak current occurrence time may be one or more of the following points in time.

1. a point in time at which higher current is instantaneously used compared to that of a preceding point in time.

2. a point in time at which the amount of current begins to gently or consistently increase compared to that of a preceding point in time.

3. a point in time at which the amount of current exceeds a threshold peak current value, which may be preset.

If the scheduler 203 is notified from at least one of the dies Die 0 to Die n in the storage 120 that the operations have been temporarily suspended, the scheduler 203 may schedule an operation resume sequence and operation resume points in time of the plurality of dies Die 0 to Die n constituting the storage 120 based on attributes of the temporarily suspended operations and peak power with respect to the allowed power budget.

In an embodiment, so as to determine an operation resume sequence and operation resume points in time, the scheduler 203 may take into account the priority of operations and commands set in the controller 110, and/or attributes (user data, map data, metadata, etc.) of data to be processed. However, the present invention is not so limited; other relevant considerations may be taken into account to determine an operation resume sequence and operation resume points in time.

The resume request device 205 may be configured to resume the temporarily suspended operations, according to a result of the scheduling of the scheduler 203. In an embodiment, the resume request device 205 may transmit a resume signal to a die to resume the temporarily suspended operation according to the scheduled sequence or time. The resume signal may be transmitted using a command interface or a control signal interface, but it is not limited thereto.

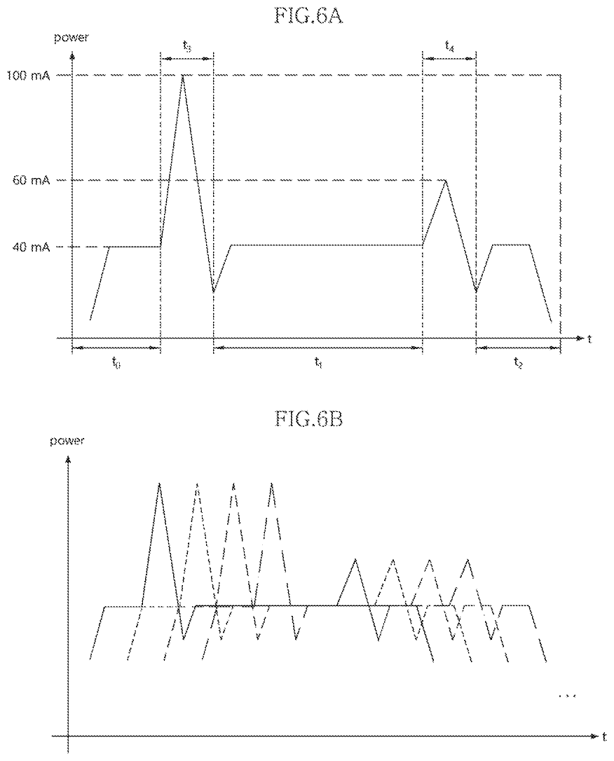

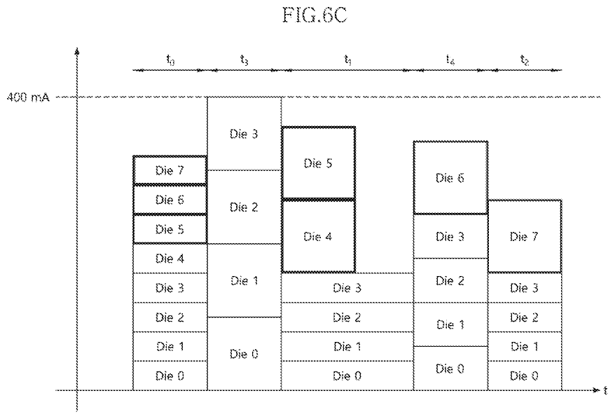

FIGS. 6A to 6C are diagrams for describing an example of scheduling according to peak current occurrence periods.

FIG. 6A illustrates a profile of the amount of current which is consumed during a read operation on the storage 120.

Referring to FIG. 6A, peak current may occur two times during the read operation. Thus, peak occurrence periods t3 and t4 including the respective peak current occurrence times may be specified by the condition setting device 201. Each of operation periods t0, t1, and t2 are distinct from the peak current occurrence periods and thus may be referred to as “normal period”.

In the illustrated embodiment, it is assumed that the power budget allowed with respect to the data storage device 10 is 400 mA, and eight dies are operated in an interleaving manner.

During the read operation, current of 100 mA may be consumed at the first peak current occurrence time, and current of 60 mA may be consumed at the second peak current occurrence time. Hence, if all of the eight dies are operated at the first peak current occurrence time, a total current of 800 mA is consumed, thus leading to an error. Also, at the second peak current occurrence time, 480 mA is needed to simultaneously operate the eight dies. Therefore, an error such as system down may be caused.

The condition setting device 201 may specify the periods t3 and t4 including the peak current occurrence times, and control the storage 120 such that the storage 120 temporarily suspends operations by itself before entering the period t3 or t4. The storage 120 may temporarily suspend the specific operations before entering the peak current occurrence period t3 or t4, and notify the controller 110 that the operations have been temporarily suspended using signals, e.g., operation confirm commands such as a status notification signal Status and a ready/busy signal/RB.

If the scheduler 203 is notified by at least one of the dies Die 0 to Die n in the storage 120 that the operations have been temporarily suspended, the scheduler 203 may schedule an operation resume sequence and operation resume times of the plurality of dies Die 0 to Die n constituting the storage 120 based on attributes of the temporarily suspended operations, peak power required at the peak current occurrence time with respect to the allowed power budget, and other relevant factors.

In an embodiment, the first peak current occurrence period t3 may be a period in which a read operation voltage applying operation is performed, and the second peak current occurrence period t4 may be a period in which read data is transmitted out of the storage 120. However, the present invention is not limited in this way; either or both of the peak occurrence periods may be periods in which an operation other than those indicated above is performed.

In the case where a plurality of peak current occurrence periods are present while a single command is processed, the amounts of current to be consumed by the respective dies in performing the resumed operations, which were suspended before the preceding peak current occurrence period t3, may affect the subsequent peak current occurrence period t4.

Therefore, taking into account the current consumption over time in the dies that resume the operations suspended before period t3, the scheduler 203 may schedule the operation resume times at the scheduled times of other operations of the dies that have been suspended before the subsequent peak current occurrence period t4.

Referring to FIG. 6B, when the scheduler 203 is notified that the plurality of dies performing the read operation have been suspended before entering the peak current occurrence period, the scheduler 203 may control the operation resume times with respect to the respective dies such that all of the dies are prevented from simultaneously operating at the peak current occurrence time. That is, the scheduler 203 may schedule the operation resume times such that the sum of peak current of dies which simultaneously operate at the peak current occurrence time is less than the allowed power budget.

Here, the operation resume sequence of the dies may be determined, taking into account the priority by operations or commands, and/or attributes (user data, map data, metadata, etc.) of the data to be processed.

Although in FIG. 6B there is illustrated the case where all of the dies Die 0 to Die n sequentially resume the operations, the present disclosure is not limited to this. In an embodiment, taking into account the allowed power budget and the peak power of each die at the peak current occurrence time, the scheduler 203 may perform the scheduling operation such that two or more dies simultaneously resume the operations.

Referring to FIG. 6C, as eight dies Die 0 to Die 7 simultaneously start to perform read operations in an interleaving manner, all of the eight dies may be in operation during the normal period t0.

Thereafter, each of the eight dies may temporarily suspend a specific operation before entering the first peak current occurrence period t3 and provide notification of such suspension to the power manager 20 of the controller 110. Taking into account peak power B (B=100 mA) of each die at the peak current occurrence time with respect to the allowed power budget A (A=400 mA), the scheduler 203 of the power manager 20 may calculate the number of dies C capable of being simultaneously operated to resume the temporarily suspended operations such that total current consumption is within the allowed power budget at the first peak current occurrence period t3 including the first peak current occurrence time. The value C may be calculated as NB, and the allowed power budget may be defined as a range.

In FIG. 6C, there is illustrated an example in which the scheduler 203 schedules the operation resume sequence such that four dies (Die 0, Die 1, Die 2, and Die 3) are operated during the first peak current occurrence period t3. However, this number may be different under different conditions.

Furthermore, the scheduler 203 may schedule the operation resume sequence such that, when the normal period t1 starts after the current consumption has been reduced as dies Die 0, Die 1, Die 2, and Die 3 continuously perform the operations, the operations of the fourth and fifth dies Die 4 and Die 5 are resumed.

Subsequently, before entering the second peak current occurrence period T4 including the second peak current occurrence time, the dies Die 0 to Die 7 may also suspend the respective operations and provide notification of such suspension to the power manager 20 of the controller 110.

Taking into account peak current of each die (e.g. 60 mA) in the second peak current occurrence period T4 and the allowed power budget (e.g., 400 mA), the scheduler 203 of the power manager 20 may schedule the operation resume sequence.

In FIG. 6C, there is illustrated an example where the operation resume sequence is scheduled such that, during the second peak current occurrence period t4 in which the peak current for each die is 60 mA, the dies Die 0, Die 1, Die 2, and Die 3 resume the operations, and the sixth die Die 6 that suspended operation before entering the first peak current occurrence period t3 resumes the suspended operation. In other words, when the dies Die 0, Die 1, Die 2, and Die 3 resume the operations during the second peak current occurrence period t4, the sixth die Die 6 may resume the operation, of which the peak current for each die had been 100 mA, and which had been suspended before the first peak current occurrence period t3. Therefore, after the scheduling, the total current consumption in the period t4 after the dies Die 0, Die 1, Die 2, and Die 3 have resumed the suspended operations is 340 mA, satisfying the allowed power budget, which in this example is 400 mA.

Furthermore, the operation resume sequence is scheduled such that, when the normal period t2 starts after the current consumption has been reduced after the second peak current occurrence period t4 has passed, the seventh die Die 7 that has suspended the operation before entering the first peak current occurrence period t3 resumes the operation.

Although not shown in FIG. 6C, the operation resume sequence may also be scheduled such that the dies Die 4 to Die 7 that have suspended the operations before entering the second peak current occurrence period t4 resume the operations after the normal period t2.

To schedule the operation resume sequence of the dies, the number of dies to be selected, among the plurality of dies, may be calculated by taking into account the priority of operations or commands, and/or attributes (user data, map data, metadata, etc.) of data to be processed.

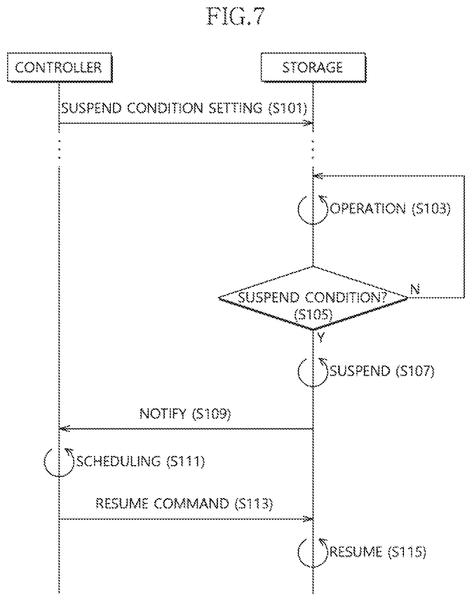

FIG. 7 is a flowchart for describing a method of operating the data storage device 10 in accordance with an embodiment.

To prevent peak current consumption times from overlapping each other when simultaneously accessing the plurality of dies Die 0 to Die n in the storage 120, the power manager 20 may specify at least one peak current occurrence time and at least one period including the time point(s) based on characteristics of the storage 120. The storage 120 may be configured or preset such that, before entering the specified peak current occurrence period(s), the operation of each of the dies Die 0 to Die n of the storage 120 is temporarily suspended (step S101).

During the operation of the data storage device 10 at step S103, if the data storage device 10 enters the pre-specified peak current occurrence period (Y at step S105), the storage 120 may temporarily suspend the operation by itself at step S107. If the data storage device 10 does not enter the peak current occurrence period N at step S105), the storage 120 may continuously perform the operation started at step S103.

If the storage 120 temporarily suspends the operation by entering the peak current occurrence period, the storage 120 notifies the controller 110 that the operation has been temporarily suspended at step S109. Such notification may be given using operation confirm commands such as a status notification signal Status and a ready/busy signal/RB, which may be transmitted to the controller 110.

If the controller 110 is notified that the operation has been temporarily suspended, the power manager 20 may schedule an operation resume sequence of the plurality of dies Die 0 to Die n constituting the storage 120 based on attributes of the temporarily suspended operation and current consumption of each die with respect to the allowed power budget at step S111.

In an embodiment, the scheduler 203 may determine the operation resume sequence, taking into account the priority of operations and commands set in the controller 110, and/or attributes (user data, map data, metadata, etc.) of data to be processed. Other relevant factors consistent with the teachings herein may also be taken into account in making such determination.

The power manager 20 may transmit a resume signal to the storage 120 according to a result of the scheduling at step S113, and then resume the operation of the storage 120 at step S115. In an embodiment, the resume signal may be transmitted using a command interface or a control signal interface, but such transfer is not limited thereto.

As such, each of the dies Die 0 to Die n in the storage 120 may temporarily suspend the operation before a specified operation requiring comparatively high current consumption is performed. If the power manager 20 of the controller 110 is notified of the temporarily suspension from each of the dies Die 0 to Die n, the power manager 20 may schedule a sequence in which the temporarily suspended operations are resumed, and control the dies Die 0 to Die n to resume the operations according to the scheduled sequence.

As a result of suspending operations requiring high current consumption to be performed by the dies Die 0 and Die n and thereafter sequentially resume the operations according to one or more considerations or factors, times at which the plurality of dies Die 0 to Die n consume peak current may be prevented from overlapping each other.

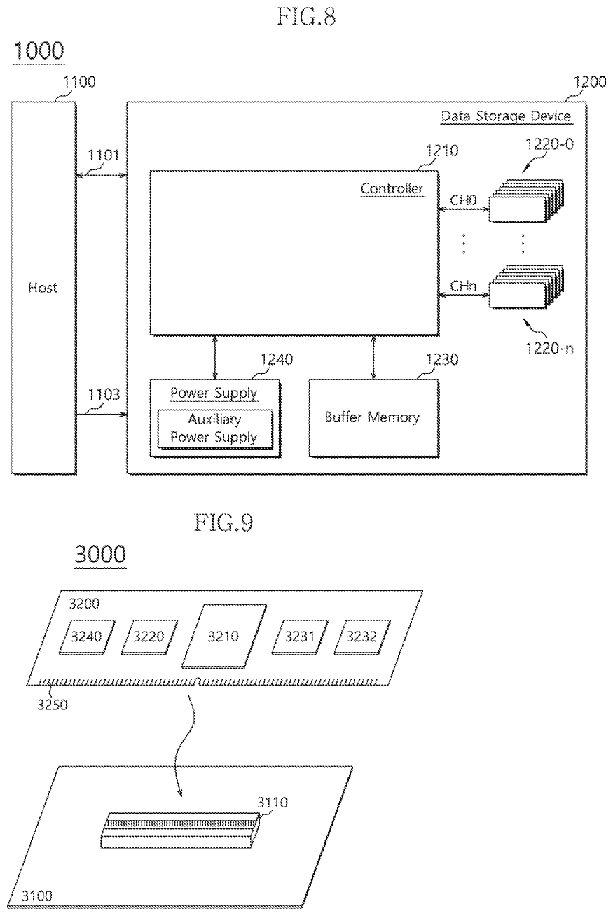

FIG. 8 is a diagram illustrating a data storage system in accordance with an embodiment.

Referring to FIG. 8, the data storage 1000 may include a host device 1100 and the data storage device 1200. In an embodiment, the data storage device 1200 may be configured to a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface, a control component, a random access memory used as a working memory, an error correction code (ECC) component, and a memory interface. In an embodiment, the controller 1210 may be configured as controller 110 comprising power manager 20 as shown is FIG. 1, FIG. 4 and FIG. 5.

The host device 1100 may exchange a signal with the data storage device 1200 through the signal connector 1101. The signal may include a command, an address, data, and the like.

The controller 1210 may analyze and process the signal received from the host device 1100. The controller 1210 may control operations of internal function blocks according to a firmware or a software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CHO to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103, to the inside of the data storage device 1200. The power supply 1240 may include an auxiliary power supply. The auxiliary power supply may supply power to allow the data storage device 1200 to be normally terminated when a sudden power-off occurs. The auxiliary power supply may include large capacity capacitors.

The signal connector 1101 may be configured as any of various types of connectors depending on an interface scheme between the host device 1100 and the data storage device 1200.

The power connector 1103 may be configured as any of various types of connectors depending on a power supply scheme of the host device 1100.

FIG. 9 is a diagram illustrating a data processing system in accordance with an embodiment. Referring to FIG. 9, the data processing system 3000 may include a host device 3100 and the memory system 3200.

The host device 3100 may be configured in the form of a board such as a printed circuit board. Although not shown, the host device 3100 may include internal function blocks for performing the function of a host device.

The host device 3100 may include a connection terminal 3110 such as a socket, a slot or a connector. The memory system 3200 may be mounted to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 comprising the power manager 20 as shown in FIG. 1, FIG. 4 and FIG. 5.

The buffer memory device 3220 may temporarily store data to be stored in the nonvolatile memory devices 3231 and 3232. Further, the buffer memory device 3220 may temporarily store the data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250, to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data and the like, as well as power may be transferred between the host device 3100 and the memory system 3200. The connection terminal 3250 may be configured as any of various types depending on an interface scheme between the host device 3100 and the memory system 3200. The connection terminal 3250 may be disposed on any one side of the memory system 3200.

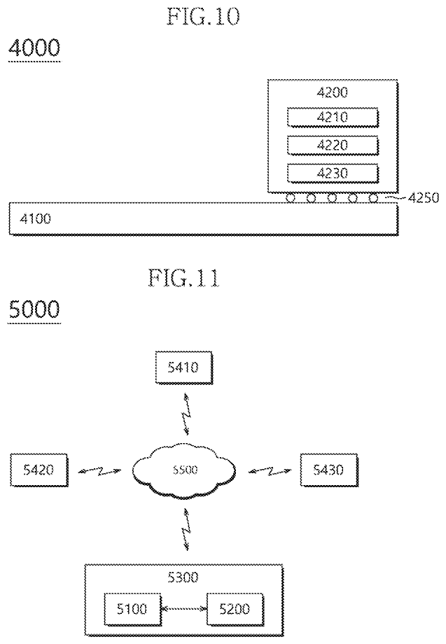

FIG. 10 is a diagram illustrating a data processing system in accordance with an embodiment. Referring to FIG. 10, the data processing system 4000 may include a host device 4100 and the memory system 4200.

The host device 4100 may be configured in the form of a board such as a printed circuit board. Although not shown, the host device 4100 may include internal function blocks for performing the function of a host device.

The memory system 4200 may be configured in the form of a surface-mounting type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 comprising the power manager 20 as shown in FIG. 1, FIG. 4 and FIG. 5.

The buffer memory device 4220 may temporarily store data to be stored in the nonvolatile memory device 4230. Further, the buffer memory device 4220 may temporarily store the data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

FIG. 11 is a diagram illustrating a network system including a data storage device in accordance with an embodiment. Referring to FIG. 11, the network system 5000 may include a server system 5300 and a plurality of client systems 5410 to 5430 which are coupled through a network 5500.

The server system 5300 may service data in response to requests from the plurality of client systems 5410 to 5430. For example, the server system 5300 may store the data provided from the plurality of client systems 5410 to 5430. For another example, the server system 5300 may provide data to the plurality of client systems 5410 to 5430.

The server system 5300 may include a host device 5100 and the memory system 5200. The memory system 5200 may be configured as the memory system 10 shown in FIG. 1, the data storage device 1200 shown in FIG. 8, the memory system 3200 shown in FIG. 9 or the memory system 4200 shown in FIG. 10.

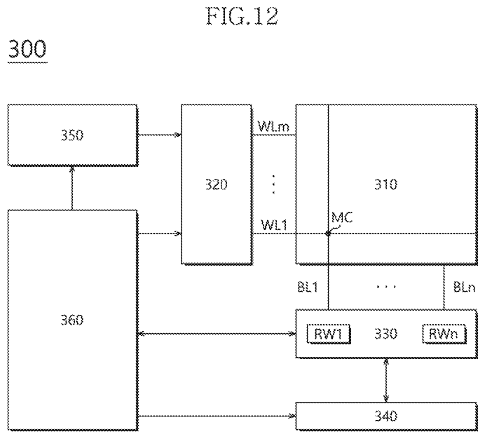

FIG. 12 is a block diagram illustrating a nonvolatile memory device included in a data storage device in accordance with an embodiment. Referring to FIG. 12, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array has a direction perpendicular to the flat surface of a semiconductor substrate. Moreover, the three-dimensional memory array means a structure including NAND strings in which memory cells are stacked in a vertical arrangement.

However, the structure of the three-dimensional memory array is not limited thereto. The memory array structure may be formed in a highly integrated manner with horizontal directionality as well as vertical directionality.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300 based on control signals provided from the external device. For example, the control logic 360 may control operations of the nonvolatile memory device 300 such as read, write and erase operations of the nonvolatile memory device 300.

While various embodiments have been illustrated and described, it will be understood to those skilled in the art that the embodiments described are examples only. Accordingly, the data storage device, the operating method thereof and the storage system including the same described herein should not be limited based on the described embodiments. Rather, the present invention embraces all variations and modifications that fall within the scope of the claims.

What is claimed is:

1. A data storage device comprising:
a storage configured to temporarily suspend an operation thereof at a specified time; and
a controller configured to schedule an operation resume time as the storage temporarily suspends the operation, and transmit an operation resume signal to the storage according to a result of the scheduling.

2. The data storage device according to claim 1, wherein the storage is configured to temporarily suspend the operation and notify the controller that the operation has been temporarily suspended.

3. The data storage device according to claim 1, wherein the storage is configured to transmit an operation confirm command to the controller to notify the controller that the operation has been temporarily suspended.

4. The data storage device according to claim 1, wherein the controller is configured to transmit the operation resume signal through a command interface.

5. The data storage device according to claim 1, wherein the controller is configured to transmit the operation resume signal through a control signal interface.

6. The data storage device according to claim 1,
wherein the storage comprises a plurality of dies, and
wherein the controller is configured such that, when the controller receives notification from at least one of the dies that an operation has been temporarily suspended, the controller schedules an operation resume time based on attributes of the temporarily suspended operation.

7. The data storage device according to claim 1,
wherein the storage comprises a plurality of dies, and
wherein the controller is configured such that, when the controller receives notification from at least one of the dies that an operation has been temporarily suspended, the controller schedules the number of dies to simultaneously resume the temporarily suspended operations and operation resume times of the dies based on current consumption of each of the plurality of dies with respect to an allowed power budget.

8. The data storage device according to claim 1,
wherein the storage comprises a plurality of dies, and
wherein the controller is configured such that, when the controller receives notification from at least one of the dies that an operation has been temporarily suspended, the controller schedules the number of dies to simultaneously resume the temporarily suspended operations and operation resume times of the dies based on attributes of the temporarily suspended operations and current consumption of each of the plurality of dies with respect to an allowed power budget.

9. A method of operating a data storage device comprising a storage and a controller configured to control the storage, the method comprising:
setting the storage to temporarily suspend an operation thereof at or before a peak current occurrence time;
temporarily suspending, by the storage, the operation as the during the operation of the storage;
scheduling, by the controller, an operation resume time; and
transmitting, by the controller, an operation resume signal to the storage according to a result of the scheduling.

10. The method according to claim 9, further comprising notifying, by the storage, after the storage temporarily suspends the operation, the controller that the storage has temporarily suspended the operation.

11. The method according to claim 9, wherein the notifying comprises using an operation confirm command to notify the controller that the operation has been temporarily suspended.

12. The method according to claim 9, wherein the operation resume signal is transmitted through a command interface.

13. The method according to claim 9, wherein the operation resume signal is transmitted through a control signal interface.

14. The method according to claim 9,
wherein the storage comprises a plurality of dies,
wherein the temporarily suspending of the operation by the storage comprises temporarily suspending an operation of at least one die before a peak current occurrence time occurs therein, and
wherein the scheduling comprises scheduling the operation resume time based on attributes of the temporarily suspended operation.

15. The method according to claim 9,
wherein the storage comprises a plurality of dies,
wherein the temporarily suspending of the operation by the storage comprises temporarily suspending an operation of at least one die before a peak current occurrence time occurs therein, and
wherein the scheduling comprises scheduling the number of dies to simultaneously resume operations and operation resume times of the dies based on current consumption of each of the plurality of dies with respect to an allowed power budget.

16. The method according to claim 9,
wherein the storage comprises a plurality of dies,
wherein the temporarily suspending of the operation by the storage comprises temporarily suspending an operation of at least one die before a peak current occurrence time occurs therein, and
wherein the scheduling comprises scheduling the number of dies to simultaneously resume operations and operation resume times of the dies based on attributes of the temporarily suspended operations and current consumption of each of the plurality of dies with respect to an allowed power budget.

17. A storage system comprising:
a host device; and
a data storage device comprising a storage configured to temporarily suspend an operation thereof at a specified time, and a controller configured to control the storage,
wherein the controller is configured to schedule an operation resume time as the storage temporarily suspends the operation, and transmit an operation resume signal to the storage according to a result of the scheduling.

18. The storage system according to claim 17, wherein the storage is configured to temporarily suspend the operation and notify the controller that the operation has been temporarily suspended.

19. The storage system according to claim 17, wherein the storage is configured to transmit an operation confirm command to the controller to notify the controller that the operation has been temporarily suspended.

20. The storage system according to claim 17, wherein the controller is configured to transmit the operation resume signal through a command interface.

21. The storage system according to claim 17, wherein the controller is configured to transmit the operation resume signal through a control signal interface.

22. The storage system according to claim 17,
wherein the storage comprises a plurality of dies, and
wherein the controller is configured such that, when the controller receives notification from at least one of the dies that an operation has been temporarily suspended, the controller schedules an operation resume time based on attributes of the temporarily suspended operation.

23. The storage system according to claim 17,
wherein the storage comprises a plurality of dies, and
wherein the controller is configured such that, when the controller receives notification from at least one of the dies that an operation has been temporarily suspended, the controller schedules the number of dies to simultaneously resume the temporarily suspended operations and operation resume times of the dies based on current consumption of each of the plurality of dies with respect to an allowed power budget.

24. The storage system according to claim 17,
wherein the storage comprises a plurality of dies, and
wherein the controller is configured such that, when the controller receives notification from at least one of the dies that an operation has been temporarily suspended, the controller schedules the number of dies to simultaneously resume the temporarily suspended operations and operation resume times of the dies based on attributes of the temporarily suspended operations and current consumption of each of the plurality of dies with respect to an allowed power budget.

25. A data storage device comprising:
one or more data storage elements each configured to suspend before a specified period an operation determined to consume a set amount of power during the specified period; and
a controller configured to control each of the data storage elements to resume the corresponding suspended operation so as to maintain power consumption of the data storage elements within a power consumption budget,
wherein each of the data storage elements notifies the controller of the corresponding suspended operation.
